(19) United States
(12) Patent Application Publication
(10) Pub. No.: US 2021/0010528 A1
(43) Pub. Date: Jan. 14, 2021

(54) CONNECTION PAIR OF THREADS OUTLINING ASYMMETRICALLY AND BIDIRECTIONAL TAPERED DUMBBELL-LIKE SHAPE HAVING SMALLER-END CONICAL DEGREE

(71) Applicant: AMICUS VERITATIS MACHINERY CO., LTD., TAIZHOU (CN)

(72) Inventor: Yihua YOU, TAIZHOU (CN)

(21) Appl. No.: 17/036,299

(22) Filed: Sep. 29, 2020

Related U.S. Application Data
(63) Continuation of application No. PCT/CN2019/081393, filed on Apr. 4, 2019.

(30) Foreign Application Priority Data
Apr. 7, 2018 (CN) 201810303106.7

(51) Int. Cl. F16B 39/30

(52) U.S. Cl. CPC F16B 39/30

(57) ABSTRACT

The disclosure relates to the general technology of equipment, and in particular relates to a connection pair of threads outlining asymmetrically and bidirectional tapered dumbbell-like shape having smaller-end conical degree. The disclosure solves the problems of poor self-positioning and poor self-locking of existing threads, etc. The disclosure is characterized that an internal thread (6) on the inner surface of a cylindrical body (2) outlines a bidirectionally tapered hole (41) (non-solid space) and an external thread (9) on the outer surface of a columnar body (3) outlines a bidirectionally truncated cone body (71) (material entity) and each complete thread body unit forms a special bidirectionally tapered body in a helical dumbbell-like shape (94) having a small middle part and two large ends, the left taper being smaller than the right taper (96).

### CROSS-REFERENCE TO RELATED APPLICATIONS

This application is a continuation of International Patent Application No. PCT/CN2019/081393, filed on Apr. 4, 2019, entitled “CONNECTION PAIR OF THREADS OUTLINING ASYMMETRICALLY AND BIDIRECTIONAL TAPERED DUMBBELL-LIKE SHAPE HAVING SMALLER-END CONICAL DEGREE,” which claims priority to China Patent Application No. 201810303106.7, filed on Apr. 7, 2018. The content of these identified applications are hereby incorporated by references.

### TECHNICAL FIELD

The disclosure relates to the field of general technology of devices, and particularly relates to connection pair of threads outlining asymmetrically and bidirectional tapered dumbbell-like shape having smaller-end conical degree, which can also be called connection pair of dumbbell-like shape (the left taper is smaller than the right taper) asymmetric bidirectional tapered threads (hereinafter referred to as connection pair of dumbbell-like shape asymmetric bidirectional tapered threads.

### BACKGROUND

The invention of thread has a profound impact on the progress of human society. Thread is one of the most basic industrial technologies. It is not a specific product, but a key generic technology in the industry. It has the technical performance that must be embodied by specific products as application carriers, and is widely applied in various industries. The existing thread technology has high standardization level, mature technical theory and long-term practical application. It is a fastening thread when used for fastening, a sealing thread when used for sealing, and a transmission thread when used for transmission. According to the thread terminology of national standards, the “thread” refers to thread bodies having the same thread profile and continuously protruding along a helical line on a cylindrical or conical surface; and the “thread body” refers to a material entity between adjacent flanks. This is also the definition of thread under global consensus.

The modern thread began in 1841 with British Whitworth thread. According to the theory of modern thread technology, the basic condition for self-locking of the thread is that an equivalent friction angle shall not be smaller than a helical rise angle. This is an understanding for the thread technology in modern thread based on a technical principle-“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, he put forward the famous law of inclined plane that the gravity of an object placed on the inclined plane in the direction of inclined plane is proportional to the sine of inclination angle. The inclined plane refers to a smooth plane inclined to the horizontal plane; the helix is a deformation of the “inclined plane”; the thread is like an inclined plane wrapped around the cylinder; and the flatter the inclined plane is, the greater the mechanical advantage is (see FIG. 8) (Jingshan Yang and Xiuya Wang, Discussion on the Principle of Screws, Disquisitiones Arithmeticae of Gauss).

The “principle of inclined plane” of the modern thread is an inclined plane slider model (see FIG. 9) which is established based on the law of inclined plane. It is believed that the thread pair meets the requirements of self-locking when a thread rise angle is less than or equal to the equivalent friction angle under the condition of little change of static load and temperature. The thread rise angle (see FIG. 10), also known as thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The invention of the wedge thread was inspired by the “wooden wedge”. Specifically, the wedge thread has a structure that a wedge-shaped inclined plane forming an angle of 25°-30° with the thread axis is located at the root of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

The modern threads are abundant in types and forms, and are all tooth-shaped threads, which are determined by the technical principle, i.e., the principle of inclined plane. Specifically, the thread formed on a cylindrical surface is called cylindrical thread; the thread formed on a conical surface is called conical thread; and the thread formed on an end surface of the cylinder or the truncated cone is called plane thread. The thread formed on the surface of an outer circle of the body is called external thread; the thread formed on the surface of an inner round hole of the body is called internal thread; and the thread formed on the end surface of the body is called end face thread. The thread that the helical direction and the thread rise angle direction conform to the left-hand rule is called left-hand thread; and the thread that the helical direction and the thread rise angle direction conform to the right-hand rule is called right-hand thread. The thread having only one helical line in the same cross section of the body is called single-start thread; the thread having two helical lines is called double-start thread; and the thread having multiple helical lines is called multi-start thread. The thread having a triangular cross section is called triangular thread; the thread having a trapezoidal cross section is called trapezoidal thread; the thread having a rectangular cross section is called rectangular thread; and the thread having a zigzag cross section is called zigzag thread.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY

Any technical theory has theoretical hypothesis background; and the thread is not an exception. With the development of science and technology, the damage to connection is not simple linear load, static or room temperature environment; and linear load, nonlinear load and even the superposition of the two cause more complex load damaging conditions and complex application conditions. Based on such recognition, the object of the present disclosure is to provide a connection pair of dumbbell-like shape asymmetric bidirectional tapered threads. This connection pair with reasonable design and simple structure has good connecting performance and locking performance.

To achieve the above object, the following technical solution is adopted in the disclosure: connection pair of dumbbell-like shape asymmetric bidirectional tapered threads (the left taper is smaller than the right taper) is composed of an asymmetric bidirectional conical internal thread and an asymmetric bidirectional conical external thread, and both of them are used to form the thread connection pair. It is a special thread pair technology that combines the technology characteristics of the cone pair and the helical motion. The bidirectional tapered thread is a thread technology which combine the bidirectional cone and the helical structure technical characteristics. The bidirectional cone is composed of two single cones. The left and right tapers face each other and the taper of the left is smaller than the right, and they are composed bidirectionally. The bidirectional cone is spirally distributed on the outer surface of the columnar body to form an external thread and/or the aforementioned bidirectional cone is spirally distributed on the inner surface of the cylindrical body to form an internal thread. Regardless of the internal thread or the external thread, the complete unit thread is a dumbbell-like shape special bidirectional conical geometry with small middle and big ends, and the taper on the left is smaller than the taper on the right.

For the connection pair of dumbbell-like shape asymmetric bidirectional tapered threads, the definition of the dumbbell-like shape asymmetric bidirectional tapered thread can be expressed as: “On a cylindrical or conical surface, the asymmetric bidirectional tapered hole (or asymmetric bidirectional truncated cone body) has prescribed right taper and left taper, and the left-end and right taper have an opposite direction, and the left taper is smaller than the right. The dumbbell-like shape special bidirectional tapered geometry is continuously and/or discontinuously distributed along the helical line in a helical shape with small middle and big ends at both ends.” The head or the tail of the bidirectional tapered thread may be an uncompleted bidirectional tapered geometry due to manufacturing and other reasons. Different from the modern thread technology, in terms of the quantity title of complete unit thread and/or incomplete unit thread, the bidirectional tapered thread is no longer based on “the number of threads” but based on “the number of pitches”. Namely, the bidirectional tapered thread may not be called a (the number of threads)-thread but called (the number of pitches)-pitch thread. The quantity title of the thread is changed on the basis of the change of technical connotation. The thread technology has changed from the engagement relationship between the internal thread and the external thread in the modern thread to the cohesion relationship between the internal thread and the external thread in the bidirectional tapered thread.

The connection pair of dumbbell-like shape asymmetric bidirectional tapered threads comprises a bidirectional truncated cone body helically distributed on an outer surface of a columnar body and a bidirectional tapered hole helically distributed on an inner surface of a cylindrical body. Namely, the bidirectional tapered thread technology comprises an external thread and an internal thread which are in mutual thread fit. The internal thread is the helically distributed bidirectional tapered hole; and the external thread is the helically distributed bidirectional truncated cone body. The internal thread is presented by the helical bidirectional tapered holes and in the form of a “non-entity space”; and the external thread is presented by the helical bidirectional truncated cone body and in the form of a “material entity”. The non-entity space refers to a space environment capable of accommodating the above material entity. The internal thread is a containing part; and the external thread is a contained part. The threads work in such a state that the internal thread and the external thread are fitted together by screwing the two bidirectional tapered geometries pitch by pitch, and the internal thread is cohered with the external thread till one side bears the load bidirectionally or both the left side and the right side bear the load bidirectionally at the same time or till the external thread and the internal thread are in interference fit. Whether the two sides bear bidirectional load at the same time is related to the actual working conditions in the application field. The bidirectional tapered hole contains and is fitted with the bidirectional truncated cone body pitch by pitch, i.e., the internal thread is fitted with the corresponding external thread pitch by pitch.

The thread connection pair is a thread pair formed by fitting a helical outer conical surface with a helical inner conical surface to form a cone pair. In the bidirectional tapered thread, both the outer conical surface of the external cone body and the inner conical surface of the internal cone body are bidirectional conical surfaces. When the thread connection pair is formed between the bidirectional tapered threads, a joint surface between the inner conical surface and the outer conical surface is used as a bearing surface; when the thread connection pair is formed between the bidirectional tapered thread and the traditional thread, a joint surface between the conical surface of the bidirectional tapered thread and the special conical surface of the traditional thread is used as a bearing surface. Namely, the conical surface is used as the bearing surface to realize the technical performance of connection. The self-locking, self-positioning, reusability, fatigue resistance and other capabilities of the thread pair mainly depend on size of the conical surfaces and taper of the cone pair forming the bidirectional tapered thread technology, i.e., the size of the conical surface and the taper of the internal thread and the external thread. The thread pair is a non-toothed thread.

Different from that the principle of inclined plane of the existing thread which shows a unidirectional force distributed on the inclined plane as well as an engagement relationship between the internal tooth bodies and the external tooth bodies, the connection pair of dumbbell-like shape asymmetric bidirectional tapered threads is composed of two plain lines of the cone body in two directions (i.e. bidirectional state) when viewed from any cross section of the single cone body distributed on either left or right side along the cone axis. The plain line is the intersection line of the conical surfaces and a plane through which the cone axis passes through. The cone principle of the connection pair of dumbbell-like shape asymmetric bidirectional tapered threads shows an axial force and a counter-axial force, both of which are combined by bidirectional forces, wherein the axial force and the corresponding counter-axial force are opposite to each other. The internal thread and the external thread are in a cohesion relationship. Namely, the thread pair is formed by cohering the external thread with the internal thread, i.e., the tapered hole (internal cone) is cohered with the corresponding tapered cone body (external cone body) pitch by pitch till the self-positioning is realized by cohesion fit or till the self-locking is realized by interference contact. Namely, the self-locking or self-positioning of the internal cone body and the external cone body is realized by radially cohering the tapered hole and the truncated cone body to realize the self-locking or self-positioning of the thread pair, rather than the thread connection pair, composed of the internal thread and the external thread in the traditional thread, which realizes its connection performance by mutual abutment between the tooth bodies.

A self-locking force will arise when the cohesion process between the internal thread and the external thread reaches certain conditions. The self-locking force is generated by a pressure produced between an axial force of the internal cone and a counter-axial force of the external cone. Namely, when the internal cone and the external cone form the cone pair, the inner conical surface of the internal cone body is cohered with the outer conical surface of the external cone body; and the inner conical surface is in close contact with the outer conical surface. The axial force of the internal cone and the counter-axial force of the external cone are concepts of forces unique to the connection pair of dumbbell-like shape asymmetric bidirectional tapered threads in the present disclosure.

The internal cone body exists in a form similar to a shaft sleeve, and generates the axial force pointing to or pressing toward the cone axis under the action of external load. The axial force is bidirectionally combined by a pair of centripetal forces which are distributed in mirror image with the cone axis as a center and are respectively perpendicular to two plain lines of the cone body; i.e., the axial force passes through the cross section of the cone axis and is composed of two centripetal forces which are bidirectionally distributed on two sides of the cone axis in mirror image with the cone axis being the center, are respectively perpendicular to the two plain lines of the cone body, and point to or press toward a common point of the cone axis; and the axial force passes through a cross section of a thread axis and is composed of two centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The axial force is densely distributed on the cone axis and/or the thread axis in an axial and circumferential manner, and corresponds to an axial force angle, wherein the axial force angle is formed by an angle between two centripetal forces forming the axial force and depends on the taper of the cone body, i.e., the taper angle.

The external cone body exists in a form similar to a shaft, has relatively strong ability to absorb various external loads, and generates a counter-axial force opposite to each axial force of the internal cone body. The counter-axial force is bidirectionally combined by a pair of counter-centripetal forces which are distributed in mirror image with the cone axis as the center and are respectively perpendicular to the two plain lines of the cone body; i.e., the counter-axial force passes through the cross section of the cone axis and is composed of two counter-centripetal forces which are bidirectionally distributed on two sides of the cone axis in mirror image with the cone axis as the center, are respectively perpendicular to the two plain lines of the cone body, and point to or press toward the common point of the cone axis; and the counter-axial force passes through the cross section of the thread axis and is composed of two counter-centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The counter-axial force is densely distributed on the cone axis and/or the thread axis in the axial and circumferential manner, and corresponds to a counter-axial force angle, wherein the counter-axial force angle is formed by an angle between the two counter-centripetal forces forming the counter-axial force and depends on the taper of the cone body, i.e., the taper angle.

The axial force and the counter-axial force start to be generated when the internal cone and the external cone of the cone pair are in effective contact, i.e., a pair of corresponding and opposite axial force and counter-axial force always exist during the effective contact of the internal cone and the external cone of the cone pair. The axial force and the counter-axial force are bidirectional forces bidirectionally distributed in mirror image with the cone axis and/or the thread axis as the center, rather than unidirectional forces. The cone axis and the thread axis are coincident axes, i.e., the same axis and/or approximately the same axis. The counter-axial force and the axial force are reversely collinear and are reversely collinear and/or approximately reversely collinear when the cone body and the helical structure are combined into the thread and form the thread pair. The internal cone and the external cone are engaged till interference is achieved, so the axial force and the counter-axial force generate a pressure on the contact surface between the inner conical surface and the outer conical surface and are densely and uniformly distributed on the contact surface between the inner conical surface and the outer conical surface axially and circumferentially. When the cohesion movement of the internal cone and the external cone continues till the cone pair reaches the pressure generated by interference fit to combine the internal cone with the external cone, i.e., the pressure enables the internal cone body to be engaged with the external cone body to form a similar integral structure and will not cause the internal cone body and the external cone body to separate from each other under the action of gravity due to arbitrary changes in a direction of a body position of the similar integral structure after the external force caused by the pressure disappears. The cone pair generates self-locking, which means that the thread pair generates self-locking. The self-locking performance has a certain degree of resistance to other external loads which may cause the internal cone body and the external cone body to separate from each other except gravity. The cone pair also has the self-positioning performance which enables the internal cone and the external cone to be fitted with each other, but not any axial force angle and/or anti-axial force angle can make self-locking and self-positioning of the cone pair.

When the axial force angle and/or the counter-axial force angle is less than 180° and greater than 127°, the cone pair has the self-locking performance. When the axial force angle and/or the counter-axial force angle is infinitely close to 180°, the cone pair has the best self-locking performance and the weakest axial bearing capacity. When the axial force angle and/or the counter-axial force angle is equal to and/or less than 127° and greater than 0°, the cone pair is in a range of weak self-locking performance and/or no self-locking performance. When the axial force angle and/or the counter-axial force angle tends to change in a direction infinitely close to 0°, the self-locking performance of the cone pair changes in a direction of attenuation until the cone pair completely has no self-locking ability; and the axial bearing capacity changes in a direction of enhancement until the axial bearing capacity is the strongest.

When the axial force angle and/or the counter-axial force angle is less than 180° and greater than 127°, the cone pair is in a strong self-positioning state, and the strong self-positioning of the internal cone body and the external cone body is easily achieved. When the axial force angle and/or the counter-axial force angle is infinitely close to 180°, the internal cone body and the external cone body of the cone pair have the strongest self-positioning ability. When the axial force angle and/or the counter-axial force angle is equal to and/or less than 127° and greater than 0°, the cone pair is in a weak self-positioning state. When the axial force angle and/or the counter-axial force angle tends to change in the direction infinitely close to 0°, the mutual self-positioning ability of the internal and external cone bodies of the cone pair changes in the direction of attenuation until the cone pair is close to have has no self-positioning ability at all.

Compared technology with the containing and contained relationship of irreversible one-sided bidirectional containment that the unidirectional tapered thread of single cone body invented by the applicant before which can only bear the load by one side of the conical surface, the connection pair of the bidirectional tapered threads of the present disclosure allows the reversible left and right-sided bidirectional containment of the bidirectional tapered threads of double cone bodies, enabling the left side and/or the right side of the conical surface to bear the load, and/or the left conical surface and the right conical surface to respectively bear the load, and/or the left conical surface and the right conical surface to simultaneously bear the load bidirectionally, and further limiting a disordered degree of freedom between the tapered hole and the truncated cone body; and the helical movement enables the thread connection pair to obtain a necessary ordered degree of freedom, thereby effectively combining the technical characteristics of the cone pair and the thread pair to form a brand-new thread technology.

When bolt and nut with bidirectional tapered thread is used, the conical surface of the bidirectional truncated cone body of the outer thread of bidirectional tapered thread matched with the conical surface of the bidirectional tapered hole of the inner thread of bidirectional tapered thread.

For the connection pair of bidirectional tapered threads, the bidirectional conical body, that is, the truncated cone body and/or the tapered hole does not have any taper or any taper angle which can realize the self-locking and/or self-positioning of the thread connection pair. The inner and outer cones of the bidirectional cone must reach a certain taper or a certain taper angle, then the connecting structure of bolt and nut with the bidirectional tapered thread can have self-locking and self-positioning properties. The taper includes the left taper and the right taper of the inner and outer thread bodies. The taper angle includes the left and right taper angles of the inner and outer thread bodies. The internal thread and external thread form the connecting structure of bolt and nut with dumbbell-shaped asymmetric bidirectional tapered thread, and the left taper is smaller than the right taper. The left taper corresponds to the left taper angle, that is, the first taper angle α1, preferably 0°<The first taper angle α1<53°, preferably, the first taper angle α1 takes a value of 2°-40°. The right taper corresponds to the right taper angle, that is, the second taper angle α2, preferably 0°<The second taper angle α2<53°, preferably, the second taper angle α2 takes a value of 2°-40°. In individual special fields, preferably, 53°≤the second taper angle α2<180°, preferably, the second taper angle α2 takes a value of 53°˜90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

For the connection pair of bidirectional tapered threads, the external thread is set on the outer surface of the columnar body to form a bolt, characterized in that the columnar body has a bolt body, and the outer surface of the bolt body has a helical shape distributed on the truncated cone body. The truncated cone body includes the asymmetric bidirectional truncated cone body. The columnar body can be solid or hollow, including cylindrical and/or non-cylindrical workpieces and objects that need to be threaded on its outer surface. The outer surfaces include cylindrical surfaces and non-cylindrical surfaces such as conical surfaces.

For the connection pair of bidirectional tapered threads, the asymmetric bidirectional truncated cone body, that is, the external thread is formed by symmetrically and oppositely jointing upper top surfaces of two truncated cone bodies with the same lower bottom surfaces and upper top surfaces and same cone height and/or different cone heights, and the lower bottom surfaces are located at both ends of the bidirectional truncated cone body to form the bidirectional tapered thread, comprising that the upper top surfaces are respectively jointed with the lower bottom surfaces of the adjacent bidirectional truncated cone bodies and/or to be respectively jointed with the lower bottom surfaces of the adjacent bidirectional truncated cone bodies in the helical shape to form the thread. The external thread comprises a first helical conical surface of the truncated cone body, a second helical conical surface of the truncated cone body and an external helical line, which form the bidirectional tapered external thread. In a cross section through which the thread axis passes, a complete single-pitch bidirectional tapered external thread, is a special bidirectional tapered geometry in the dumbbell-like shape small in the middle and large in both ends. The bidirectional truncated cone body comprises a conical surface of the bidirectional truncated cone body. The angle formed between the two plain lines of the left conical surface of the bidirectional truncated cone body, i.e., the first helical conical surface of the truncated cone body, is the first taper angle. The left taper is formed on the first helical conical surface of the truncated cone body and is subjected to a right-direction distribution. The angle formed between the two plain lines of the right conical surface of the bidirectional truncated cone body, i.e., the second helical conical surface of the truncated cone body, is the second taper angle. The right taper is formed on the second helical conical surface of the truncated cone body and is subjected to a left-direction distribution. The taper directions corresponding to the first taper angle and the second taper angle are opposite. The plain line is an intersection line of the conical surface and the plane through which the cone axis passes. A shape formed by the first helical conical surface and the second helical conical surface of the truncated cone body of the bidirectional truncated cone body is the same as a shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body, wherein the right-angled side is coincident with the central axis of the columnar body; and the right-angled trapezoid union is formed by symmetrically and oppositely jointing upper sides of two right-angled trapezoids with the same lower sides and upper sides and same and/or different right-angled sides. The right-angled trapezoid union refers to a special geometry, which is formed by symmetrically and oppositely jointing the upper sides of two right-angled trapezoids with the same lower sides and upper sides and same and/or different right-angled sides and has the lower sides respectively located at both ends of the right-angled trapezoid union.

For the connection pair of bidirectional tapered threads, the internal thread of the bidirectional tapered thread technology is arranged in the inner surface of the cylindrical body, wherein the cylindrical body is provided with a nut body; the tapered hole is helically distributed on the inner surface of the nut body, comprising the bidirectional tapered hole. The tapered hole includes an asymmetric bidirectional tapered hole. The cylindrical body comprises cylindrical and/or non-cylindrical workpieces and objects which need to be machined with the internal threads in inner surfaces thereof, wherein the inner surfaces include geometric shapes of inner surfaces such as cylindrical surfaces, non-cylindrical surfaces such as conical surfaces, and the like.

For the connection pair of bidirectional tapered threads, the asymmetric bidirectional tapered hole, that is, the internal thread, is formed by symmetrically and oppositely jointing upper top surfaces of two tapered holes with the same lower bottom surfaces and upper top surfaces and different cone heights, and the lower bottom surfaces are located at both ends of the bidirectional tapered hole to form the bidirectional tapered thread, comprising that the upper top surfaces are respectively jointed with the lower bottom surfaces of the adjacent bidirectional tapered holes and/or to be respectively jointed with the lower bottom surfaces of the adjacent bidirectional tapered holes in the helical shape to form the thread. The internal thread comprises the first helical conical surface of the tapered hole, the second helical conical surface of the tapered hole and the internal helical line, which form the bidirectional tapered internal thread. In the cross section passing through the thread axis, the complete single-pitch bidirectional tapered internal thread, is a special bidirectional tapered geometry in the dumbbell-like shape and with a small middle and two large ends. The bidirectional tapered hole comprises a conical surface of the bidirectional tapered hole. The angle formed by the two plain lines of the left conical surface of the bidirectional tapered hole, i.e., the first helical conical surface of the tapered hole, is the first taper angle. The left taper is formed on the first helical conical surface of the tapered hole and is subjected to the right-direction distribution. The angle formed by the two plain lines of the right conical surface of the bidirectional tapered hole, i.e., the second helical conical surface of the tapered hole, is the second taper angle. The right taper is formed on the second helical conical surface of the tapered hole and is subjected to the left-direction distribution. The taper directions corresponding to the first taper angle and the second taper angle are opposite. The plain line is an intersection line of the conical surface and the plane through which the cone axis passes. A shape formed by the first helical conical surface and the second helical conical surface of the tapered hole of the bidirectional tapered hole is the same as a shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body, wherein the right-angled side is coincident with the central axis of the cylindrical body; and the right-angled trapezoid union is formed by symmetrically and oppositely jointing upper sides of two right-angled trapezoids with the same lower sides and upper sides and same and/or different right-angled sides. The right-angled trapezoid union refers to a special geometry, which is formed by symmetrically and oppositely jointing the upper sides of two right-angled trapezoids with the same lower sides and upper sides and same and/or different right-angled sides and has the lower sides respectively located at both ends of the right-angled trapezoid union.

In the aforementioned connection pair of dumbbell-like shape asymmetric bidirectional tapered threads, the junction of two adjacent helical conical surfaces of the external thread and the junction of two adjacent helical conical surfaces of the internal thread have connected forms such as sharp corners and/or non-sharp corners. The sharp corners are relatively non-sharp corners and refer to the structural forms without special non-sharp corner treatment.

In the aforementioned connection pair of dumbbell-like shape asymmetric bidirectional tapered threads, when the connection form is a sharp corner, its characteristics are as follows. For the same helical of the bidirectional truncated conical body, the joint between the first helical conical surface of the truncated conical body and the second helical conical surface of the truncated conical body, that is, the small diameter of the external thread, is connected by an inner sharp corner structure and forms a outer helical line distributed spirally. For the same helical of the bidirectional truncated conical body, the joint between the first helical conical surface of the truncated conical body and the neighbouring second helical conical surface of the truncated conical body, and/or the joint between the second helical conical surface of the truncated conical body and the neighbouring first helical conical surface of the truncated conical body, that is, the major diameter of the external thread, is connected by an outer sharp corner structure and forms a outer helical line distributed spirally. For the same helical of the bidirectional tapered hole, the joint between the first helical conical surface of the tapered hole and the second helical conical surface of the tapered hole, that is, the small diameter of the internal thread, is connected by an outer sharp corner structure and forms a inner helical line distributed spirally. For the same helical of the bidirectional tapered hole, the joint between the first helical conical surface of the tapered hole and the neighbouring second helical conical surface of the tapered hole, and/or the joint between the second helical conical surface of the tapered hole and the neighbouring first helical conical surface of the tapered hole, that is, the major diameter of the internal thread, is connected by an inner sharp corner structure and forms a inner helical line distributed spirally. The thread structure is more compact, the strength is higher, the bearing value is large. It has good mechanical connection, locking and sealing performance, and the physical space for taper thread processing is more spacious.

In the aforementioned connection pair of dumbbell-like shape asymmetric bidirectional tapered threads, when the connection form is a non-sharp corner, its characteristics are as follows. For the same helical of the bidirectional truncated conical body, the joint between the first helical conical surface of the truncated conical body and the second helical conical surface of the truncated conical body, that is, the small diameter of the external thread, is connected by an inner non-sharp corner structure and forms a outer helical structure which is groove or arc. For the same helical of the bidirectional truncated conical body, the joint between the first helical conical surface of the truncated conical body and the neighbouring second helical conical surface of the truncated conical body, and/or the joint between the second helical conical surface of the truncated conical body and the neighbouring first helical conical surface of the truncated conical body, that is, the major diameter of the external thread, is connected by an outer non-sharp corner structure and forms a outer helical structure which is flat top or arc. For the same helical of the bidirectional tapered hole, the joint between the first helical conical surface of the tapered hole and the second helical conical surface of the tapered hole, that is, the small diameter of the internal thread, is connected by an outer non-sharp corner structure and forms a inner helical structure which is flat top or arc. For the same helical of the bidirectional tapered hole, the joint between the first helical conical surface of the tapered hole and the neighbouring second helical conical surface of the tapered hole, and/or the joint between the second helical conical surface of the tapered hole and the neighbouring first helical conical surface of the tapered hole, that is, the major diameter of the internal thread, is connected by an inner non-sharp corner structure and forms a inner helical structure which is groove or arc. The inner non-sharp corner means that its cross-section is a geometric shape such as a groove or an are, and the external non-sharp corner refers to its cross-section is a geometric shape such as a flat top or an arc. It can avoid the interference when the internal thread and the external thread are screwed together, and can store oil and dirt. Depending on the actual application, the small diameter of the external thread and the major diameter of the internal thread can be treated with grooves or arc structures while the major diameter of the external thread and the small diameter of the internal thread can be treated with sharp corner structure. And/or the major diameter of external thread and the small diameter of internal thread can be treated with flat top or are structures while the small diameter of the external thread and the major diameter of the internal thread can be treated with sharp corner structure. And/or the small diameter of external thread and the major diameter of internal thread can be treated with groove or arc structures while the major diameter of the external thread and the small diameter of the internal thread can be treated with flat top or arc structures.

The connection pair of dumbbell-like shape asymmetric bidirectional tapered threads is connected in transmission through the screw connection of the bidirectional tapered hole and the bidirectional truncated cone body, and the load is bidirectional. When the external thread and the internal thread form a thread pair, there must be a clearance between the bidirectional truncated cone body and the bidirectional tapered hole. If oil and other media are lubricated between the internal thread and the external thread, it will easily form a bearing oil film. The clearance is conducive to the formation of the bearing oil film. The connection pair of dumbbell-like shape asymmetric bidirectional tapered threads, applied to the transmission connection, are equivalent to a group of sliding bearing pairs composed of one pair and/or several pairs of sliding bearings. In other words, each section of bidirectional conical internal thread bidirectionally contains a corresponding section of bidirectional conical external thread to form a pair of sliding bearing, and the number of sliding bearings is adjusted according to the application conditions. In other words, the effective bidirectional joint of the bidirectional conical internal thread and the bidirectional conical external thread, that is, thread pitches of the effective contact envelopment of the containment and contained, should be designed according to the application conditions. By the bidirectional tapered hole containing the bidirectional truncated cone body, radial, axial, angular, circumferential and so on, the multi-directional positioning is achieved. Preferably, by the bidirectional tapered hole containing the bidirectional truncated cone body, the radial and circumferential as main positioning, the axial and angular as auxiliary positioning, the multi-directional positioning is supplemented until the conical surface of the bidirectional tapered hole and the conical surface of the bidirectional truncated cone body are enclosed to achieve self-positioning or until the sizing interference contact to achieve self-locking. This produces a special composite technology of the cone pair and the thread pair to ensure the tapered thread technology, especially transmission connection accuracy, efficiency and reliability of the connection pair of asymmetric bidirectional tapered threads.

For the connection pair of dumbbell-like shape asymmetric bidirectional tapered threads, the fastened and sealed technical performance is realized by the screw connection of the bidirectional tapered hole and the bidirectional truncated cone body, that is, by the first helical conical surface of the tapered hole and the first helical conical surface of the truncated cone body sizing interference and/or the second helical conical surface of the tapered hole and the second helical conical surface of the truncated cone body sizing interference. According to the application conditions, that achieves load in one direction and/or load in two directions simultaneously. With the bidirectional truncated cone body and the bidirectional tapered hole guided by the helical line, the inner and outer diameters of inner and outer cone are centered until the first helical conical surface of the tapered hole encloses with the first helical conical surface of the truncated cone body to achieve load in one direction or in two directions at the same time sizing cooperation or until sizing interference contact. And/or the inner and outer diameters of inner and outer cone are centered until the second helical conical surface of the tapered hole encloses with the second helical conical surface of the truncated cone body to achieve load in one direction or in two directions at the same time sizing cooperation or until sizing interference contact. In other words, by the self-locking of the bidirectional tapered hole containing the bidirectional truncated cone body, radial, axial, angular, circumferential and so on, the multi-directional positioning is achieved. Preferably, by the bidirectional tapered hole containing the bidirectional truncated cone body, the radial and circumferential as main positioning, the axial and angular as auxiliary positioning, the multi-directional positioning is supplemented until the conical surface of the bidirectional tapered hole and the conical surface of the bidirectional truncated cone body are enclosed to achieve self-positioning or until the sizing interference contact achieve self-locking. This produces a special composite technology of the cone pair and the thread pair to ensure the tapered thread technology, especially the efficiency and reliability of the bolt and nut with bidirectional tapered thread, thereby to achieve the technical performance of mechanical mechanism connection, locking, anti-loosening, bearing, fatigue and sealing.

Therefore, for the connection pair of dumbbell-like shape asymmetric bidirectional tapered threads, the technical performance of transmission accuracy and efficiency, bearing capacity, self-locking locking force, anti-loosening capacity, and sealing is related to the first helical conical surface of the truncated cone body and its left taper, that is, the first taper angle α1, the second helical conical surface of the truncated cone body and its right taper, that is, the second taper angle α2, the first helical conical surface of the tapered hole and its left taper, that is, the first taper angle α1, and the second helical conical surface of the tapered hole and its right taper, that is, the second taper angle α2. The material friction coefficient, processing quality and application conditions of the columnar body and the cylindrical body also have a certain influence on the cone fit.

For the connection pair of dumbbell-like shape asymmetric bidirectional tapered threads, when the right-angled trapezoid union rotates a circle at a constant speed, an axial movement distance of the right-angled trapezoid union is at least double a length of the sum of the right-angled sides of the two right-angled trapezoids with the same lower sides and upper sides and same right-angled side and/or different right-angled sides. The structure ensures that the first helical conical surface and the second helical conical surface of the truncated cone body as well as the first helical conical surface and the second helical conical surface of the tapered hole have sufficient length, thereby ensuring that the conical surface of the bidirectional truncated cone body and the conical surface of the bidirectional tapered hole have sufficient effective contact area and strength and the efficiency required by helical movement during fitting.

For the connection pair of dumbbell-like shape asymmetric bidirectional tapered threads, when the right-angled trapezoid union rotates a circle at a constant speed, an axial movement distance of the right-angled trapezoid union is equal to a length of the sum of the right-angled sides of two right-angled trapezoids with the same lower sides and upper sides and same right-angled side and/or different right-angled sides. The structure ensures that the first helical conical surface of the truncated cone body and the second helical conical surface of the truncated cone body as well as the first helical conical surface of the tapered hole and the second helical conical surface of the tapered hole have sufficient length, thereby ensuring that the conical surface of the bidirectional truncated cone body and the conical surface of the bidirectional tapered hole have sufficient effective contact area and strength and the efficiency required by helical movement during fitting.

For the above-mentioned connection pair of dumbbell-like shape asymmetric bidirectional tapered threads, the first helical conical surface of the truncated cone body and the second helical conical surface of the truncated cone body are both continuous helical surfaces or discontinuous helical surfaces; The first helical conical surface of the tapered hole and the second helical conical surface of the tapered hole are both continuous helical surfaces or discontinuous helical surfaces. Preferably, the first helical conical surface of the truncated cone body, the second helical conical surface of the truncated cone body, the first helical conical surface of the tapered hole, and the second helical conical surface of the tapered hole are continuous helical surfaces.

For the above-mentioned connection pair of dumbbell-like shape asymmetric bidirectional tapered threads, when the cylindrical body connecting hole is screwed into the screw-in end of the columnar body, there is a screw-in direction requirement, that is, the cylindrical body connecting hole cannot be rotated in the opposite direction into the screw-in end of the columnar body. The contact surface of the first helical conical surface of the truncated conical body and the first helical conical surface of the tapered hole is supporting surface and/or interference fit and/or the contact surface of the second helical conical surface of the truncated conical body and the second helical conical surface of the tapered hole is the supporting surface and/or interference fit. The angle between the two element lines of the first helical conical surface, that is, the left conical surface of the external and/or internal, is the first taper angle. The angle between the two element lines of the second helical conical surface, that is, the right conical surface of the external and/or internal, is the second taper angle. The corresponding taper directions of the first taper angle and the second taper angle are opposite. The thread connection function is realized by the first helical conical surface of the internal thread and the first helical conical surface of the external thread contacting and/or sizing cooperation, and/or by the second helical conical surface of the internal thread and the second helical conical surface of the external thread contacting and/or sizing cooperation.

For the connection pair of dumbbell-like shape asymmetric bidirectional tapered threads, one end of the columnar body is provided with a head having a size larger than the outer diameter of the columnar body, and/or one and/or both ends of the columnar body are provided with a head having a size smaller than the small diameter of the external bidirectional tapered thread of the columnar body screw body. The connecting hole is a threaded hole provided in the nut. That is to say, the columnar body and the head are connected as bolt. The columnar body without the head, and/or the columnar body with the heads at both ends which are smaller than the small diameter of the external bidirectional tapered thread, and/or the columnar body with no-thread in the middle and external bidirectional tapered threads at both ends, are the studs. The connecting hole is arranged in the nut.

Compared with the prior art, the connection pair of dumbbell-like shape asymmetric bidirectional tapered threads has the advantages of reasonable design, simple structure, convenient operation, large locking force, high bearing capacity, excellent anti-loosening performance, high transmission efficiency and precision, good mechanical sealing effect and good stability, realizes the fastening and connecting functions through bidirectional bearing or sizing of the cone pair formed by coaxially aligning the inner diameter and the outer diameter of the internal cone and the external cone to achieve interference fit, can prevent loosening phenomenon during connection, and has self-locking and self-positioning functions.

### BRIEF DESCRIPTION OF THE DRAWINGS

FIG. 1 is a schematic diagram of a connection pair of dumbbell-like shape (the left taper is smaller than the right taper) asymmetric bidirectional tapered threads according to embodiment 1 of the present disclosure.

FIG. 2 is a schematic diagram of connection pair of dumbbell-like shape (the left taper is smaller than the right taper) asymmetric bidirectional tapered threads and the complete unit thread of external thread according to the embodiment 1 of the present disclosure.

FIG. 3 is a schematic diagram of the connection pair of dumbbell-like shape (the left taper is smaller than the right taper) asymmetric bidirectional tapered threads and the complete unit thread of internal thread according to the embodiment 1 of the present disclosure.

FIG. 4 is a schematic diagram of a connection pair of dumbbell-like shape (the left taper is smaller than the right taper) asymmetric bidirectional tapered threads according to embodiment 2 of the present disclosure.

FIG. 5 is a schematic diagram of a connection pair of dumbbell-like shape (the left taper is smaller than the right taper) asymmetric bidirectional tapered threads according to embodiment 3 of the present disclosure.

FIG. 6 is a schematic diagram of a connection pair of dumbbell-like shape (the left taper is smaller than the right taper) asymmetric bidirectional tapered threads according to embodiment 4 of the present disclosure.

FIG. 7 is a schematic diagram of a connection pair of dumbbell-like shape (the left taper is smaller than the right taper) asymmetric bidirectional tapered threads according to embodiment 5 of the present disclosure.

FIG. 8 is an illustration of “the thread of the existing thread technology is an inclined plane on a cylindrical or conical surface” involved in the background technology of the present disclosure.

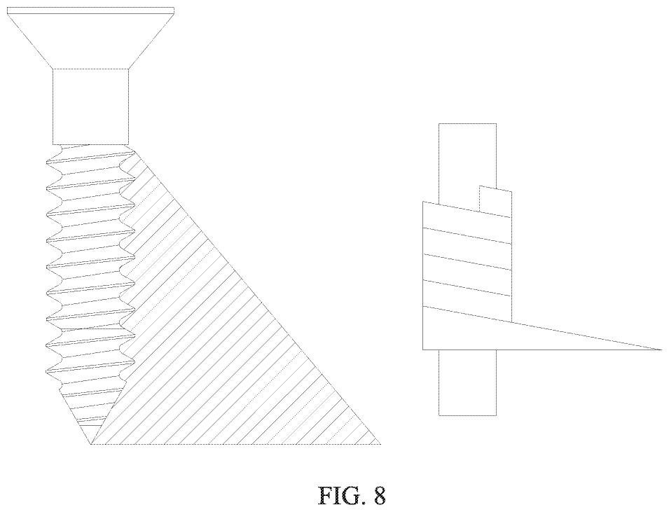

FIG. 9 is an illustration of the “an inclined plane slider model of the principle of the existing thread technology—the principle of inclined plane” involved in the background technology of the present disclosure.

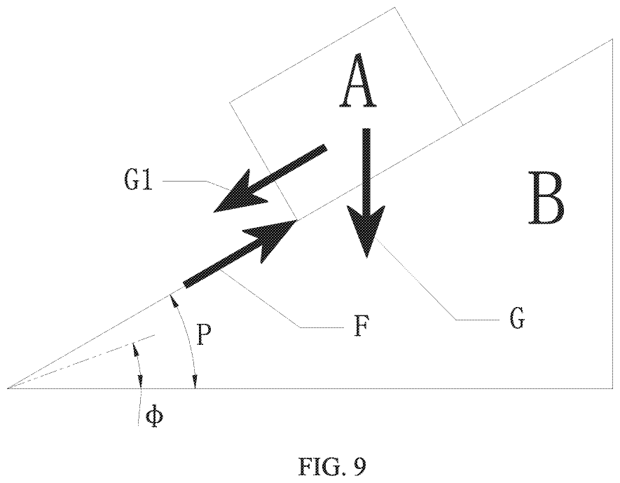

FIG. 10 is an illustration of the “a thread rise angle of the existing thread technology” involved in the background technology of the present disclosure.

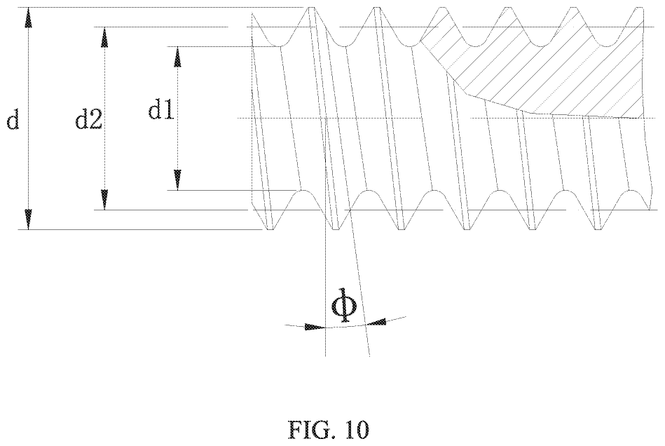

In the figure, tapered thread 1, cylindrical body 2, nut body 21, nut body 22, columnar body 3, screw body 31, tapered hole 4, bidirectional tapered hole 41, conical surface 42 of the tapered hole, first helical conical surface 421 of the tapered hole, first taper angle α1, second helical conical surface 422 of the tapered hole, second taper angle α2, internal helical line 5, internal thread 6, truncated cone body 7, bidirectional truncated cone body 71, conical surface 72 of the truncated cone body, first helical conical surface 721 of the truncated cone body, first taper angle α1, second helical conical surface 722 of the truncated cone body, second taper angle α2, external helical line 8, external thread 9, dumbbell-like shape 94, left taper 95, right taper 96, left-direction distribution 97, right-direction distribution 98, thread connection pair and/or thread pair 10, clearance 101, locking supporting surface 111, locking supporting surface 112, tapered thread supporting surface 122, tapered thread supporting surface 121, workpiece 130, nut body locking direction 131, washer 132, cone axis 01, thread axis 02, slider A on the inclined surface, inclined surface B, gravity G, gravity component Gi along the inclined plane, friction force F, thread rise angle φ, equivalent friction angle P, major diameter d of the traditional external thread, minor diameter d1 of the traditional external thread and pitch diameter d2 of the traditional external thread.

### DETAILED DESCRIPTION OF EMBODIMENTS

The present disclosure will be further described in detail below with reference to the drawings and specific embodiments.

### Embodiment 1

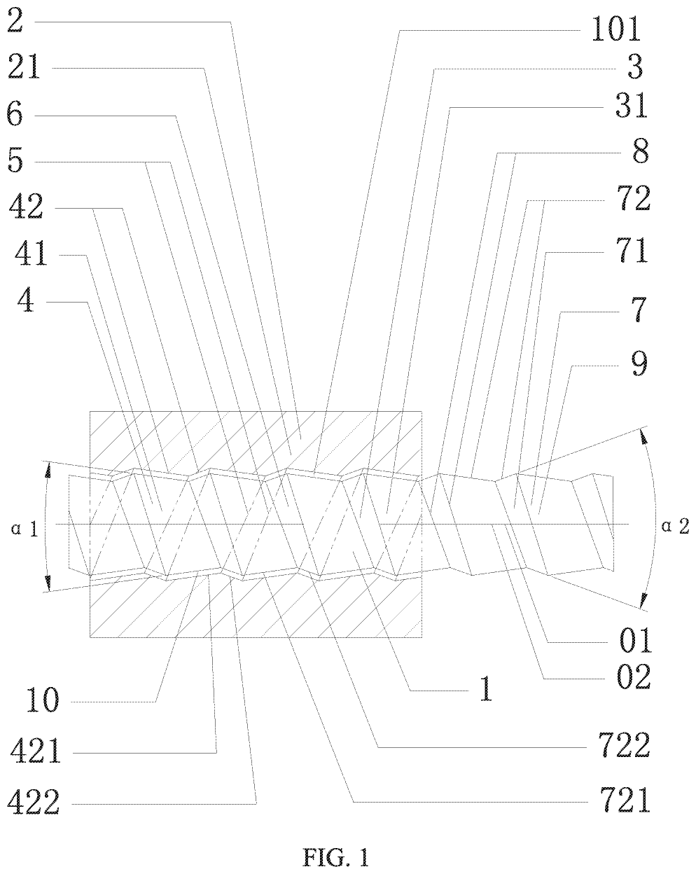

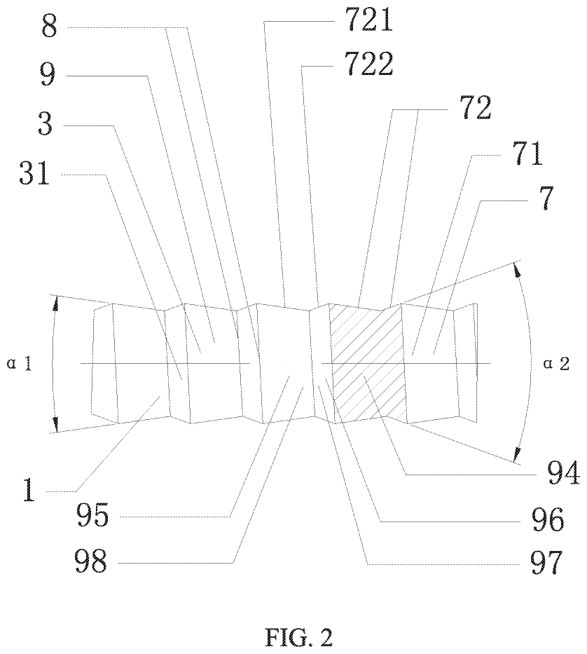

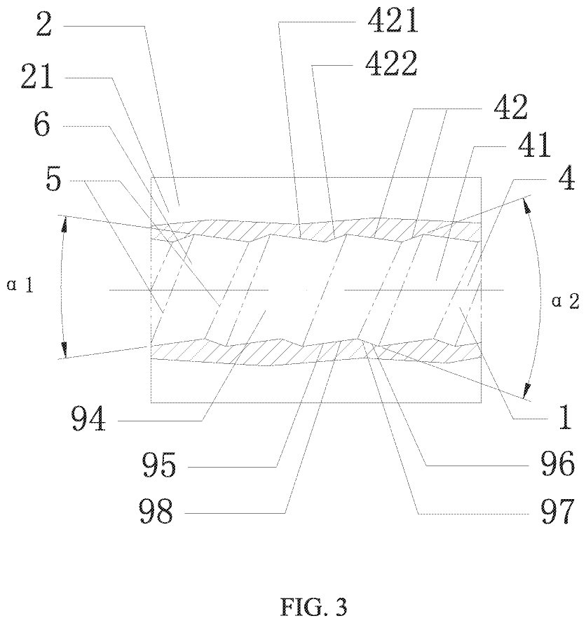

As shown in FIG. 1, FIG. 2, and FIG. 3, the connection pair of dumbbell-like shape asymmetric bidirectional tapered threads, includes a bidirectional truncated cone body 71 spirally distributed on the outer surface of the columnar body 3 and a bidirectional tapered hole 41 spirally distributed on the inner surface the cylindrical body 2, that is, including an external thread 9 and an internal thread 6 that are threaded to each other. The internal thread 6 is distributed in a helical bidirectional tapered hole 41 and exists in the form of a “non-solid space”. The external thread 9 is distributed in a helical bidirectional truncated cone body 71 and exists in the form of a “material entity”. The internal thread 6 and the external thread 9 are the relationship between the containing part and the contained part: the internal thread 6 and the external thread 9 are sections of the bidirectional conical geometric body which are screwed together until the interference cooperation. In other words, the bidirectional tapered hole 41 contains the bidirectional truncated cone body 71 section by section. The bidirectional containment limits the disorder degree of freedom between the tapered hole 4 and the truncated cone body 7. The helical movement allows the tapered thread connection pair 10 of the bolt and nut with the bidirectional tapered thread to obtain the necessary orderly degree of freedom. This effectively synthesizes the technical characteristics of the cone pair and the thread pair.

The connection pair of dumbbell-like shape asymmetric bidirectional tapered threads in this embodiment is used with the conical surface 72 of the truncated cone body and the bidirectional tapered hole cone surface 42 cooperating with each other.

For the connection pair of dumbbell-like shape asymmetric bidirectional tapered threads in this embodiment, when the conical cone body 7 and/or the tapered hole 4 of the tapered thread connection pair 10 reach a certain taper, that is, the cone that makes up the cone pair reaches a certain taper angle, the tapered thread connection pair 10 is self-locking and self-locating. The taper includes a left taper 95 and a right taper 96. The taper angle includes a left taper angle and a right taper angle. In this embodiment, the asymmetric bidirectional tapered thread 1 has a left taper 95 less than a right taper 96. The left taper 95 corresponds to the left taper angle, that is, the first taper angle α1. Preferably, 0°<the first taper angle α<153°. Preferably, the first taper angle α1 takes a value of 2°-40°. The right taper 96 corresponds to the right taper angle, that is, the second taper angle α2. Preferably, 0°<the second taper angle α2<53°. Preferably, the second taper angle α2 takes a value of 2°-40°. In some special connection application fields where self-locking is not required and/or self-positioning is required weakly and/or axial bearing capacity is required strongly, preferably, 53°≤the second taper angle α2<180°, and preferably, the second taper angle α2 takes a value of 53°-90°.

The external thread 9 is arranged on the outer surface of the columnar body 3, characterized in that the columnar body body 3 has a screw body 31, and the outer surface of the screw body 31 has a truncated cone body 7 distributed in a helical shape. The truncated cone body 7 includes an asymmetric bidirectional truncated cone body 71. The asymmetric bidirectional truncated cone body 71 is a special dumbbell-like shape 94 bidirectional cone geometry. The columnar body 3 can be solid or hollow, including cylinders, cones, pipes, etc.

The dumbbell-like shape 94 asymmetric bidirectional truncated cone body 71 is characterized in that is formed by the upper top surfaces of two truncated cone bodies join to each other symmetrically. The two truncated cone bodies have the same lower bottom surface and the same upper top surface but different cone heights. The lower bottom surfaces are at the two ends of the bidirectional truncated cone body 71. When the asymmetric tapered thread 1 is formed, the upper bottom surfaces are joined respectively to the bottom surfaces of the bidirectional truncated cone body 71. The outer surface of the truncated cone body 7 has a conical surface of the asymmetric bidirectional truncated cone body 72. The external thread 9 includes the first helical conical surface of the truncated cone body 721, the second helical conical surface of the truncated cone body 722, and the external helical line 8. In the section passing through the thread axis 02, the complete single-section asymmetric bidirectional conical external thread 9 is a complete single-section asymmetrical bidirectional conical dumbbell-like shape 94 geometry with a smaller middle, larger ends, and the taper of the left truncated cone is smaller than that of the right truncated cone. The asymmetric bidirectional truncated cone body 71 includes the conical surface of the bidirectional truncated cone body 72. The angle between two element lines of the left side of the conical surface, that is, the first helical conical surface of the truncated cone body 721 is the first taper angle α1. The first helical conical surface of the truncated cone body 721 forms a left taper 95 and is in right-direction distribution 98. The angle between two element lines of the right side of the conical surface, that is, the second helical conical surface of the truncated cone body 722 is the second taper angle α2. The second helical conical surface of the truncated cone body 721 forms a right taper 96 and is in left-direction distribution 97. The first taper angle α1 and the second taper angle α2 correspond to the same direction of taper. The element line is the intersection of the surface of the cone and the plane passing through the cone axis 01. The upper bases of two right-angled trapezoids with the same lower base and the same upper base but different right-angle sides, which coincide with the central axis of the columnar body 3, are symmetrical and joined to each other to form a right-angled trapezoidal combination. The center rotates at a uniform speed in the circumferential direction, and the right-angled trapezoidal combined body moves axially along the central axis of the columnar body 3 at a uniform speed at the same time, and the two oblique sides of the right-angled trapezoidal combined body form a gyrating body. The helical outer surface of the gyrating body has the same shape as the first helical conical surface of the truncated cone body 721 and the second helical conical surface of the truncated cone body 722 of the bidirectional truncated cone body 71. The right-angled trapezoidal combination refers to a special geometric body with two right-angled trapezoids with the same lower base and the same upper base but different right-angled sides. The upper bases are symmetrical and joined to each other, and the lower bases are respectively at both ends of the right-angled trapezoidal combination.

The internal thread 6 is arranged on the inner surface of the cylindrical body 2, which is characterized in that the cylindrical body 2 includes a nut body 21, a nut body 22. The inner surfaces of the nut body 21 and the nut body 22 has spiral-distributed cone holes 4. The cone hole 4 includes the asymmetric bidirectional cone hole 41. The asymmetric bidirectional cone hole 41 is a special dumbbell-like shape 94 bidirectional cone geometry. The cylindrical body 2 includes the workpiece and object that needs to be processed on its inner surface, such as a cylindrical body and/or a non-cylindrical body.

The dumbbell-like shape 94 asymmetric bidirectional tapered hole 41 is characterized in that is formed by the upper top surfaces of two truncated cone bodies join to each other symmetrically. The two tapered holes have the same lower bottom surface and the same upper top surface but different cone heights. The lower bottom surfaces are at the two ends of the bidirectional tapered hole 41. When the asymmetric tapered thread 1 is formed, the upper bottom surfaces are joined respectively to the bottom surfaces of the bidirectional tapered hole 41. The outer surface of the tapered hole 4 has a conical surface of the asymmetric bidirectional tapered hole 42. The internal thread 6 includes the first helical conical surface of the tapered hole 421, the second helical conical surface of the tapered hole 422, and the internal helical line 6. In the section passing through the thread axis 02, the complete single-section asymmetric bidirectional conical internal thread 6 is a complete single-section asymmetrical bidirectional conical dumbbell-like shape 94 geometry with a smaller middle, larger ends, and the taper of the left truncated cone is smaller than that of the right truncated cone. The asymmetric bidirectional tapered hole 41 includes the conical surface of the bidirectional tapered hole 42. The angle between two element lines of the left side of the conical surface, that is, the first helical conical surface of the tapered hole 421 is the first taper angle α1. The first helical conical surface of the tapered hole 421 forms a left taper 95 and is in right-direction distribution 98. The angle between two element lines of the right side of the conical surface, that is, the second helical conical surface of the tapered hole 422 is the second taper angle α2. The second helical conical surface of the tapered hole 421 forms a right taper 96 and is in left-direction distribution 97. The first taper angle α1 and the second taper angle α2 correspond to the same direction of taper. The element line is the intersection of the surface of the cone and the plane passing through the cone axis 01. The upper bases of two right-angled trapezoids with the same lower base and the same upper base but different right-angle sides, which coincide with the central axis of the cylindrical body 2, are symmetrical and joined to each other to form a right-angled trapezoidal combination. The center rotates at a uniform speed in the circumferential direction, and the right-angled trapezoidal combined body moves axially along the central axis of the cylindrical body 2 at a uniform speed at the same time, and the two oblique sides of the right-angled trapezoidal combined body form a gyrating body. The helical outer surface of the gyrating body has the same shape as the first helical conical surface of the tapered hole 421 and the second helical conical surface of the tapered hole 422 of the bidirectional tapered hole 41. The right-angled trapezoidal combination refers to a special geometric body with two right-angled trapezoids with the same lower base and the same upper base but different right-angled sides. The upper bases are symmetrical and joined to each other, and the lower bases are respectively at both ends of the right-angled trapezoidal combination.

For the connection pair of dumbbell-like shape asymmetric bidirectional tapered threads in this embodiment, the junction of the adjacent helical conical surface of the external thread 9 and the junction of the adjacent helical conical surface of the internal thread 6 are connected by sharp corner. The sharp corner, relative to the non-sharp corner, refers to the structure without special non-sharp corner treatment.

The dumbbell-like shape (94) bidirectional truncated cone body 71 and bidirectional tapered hole 41 are characterized as follows. For the same helical of the bidirectional truncated conical body 71, the joint between the first helical conical surface of the truncated conical body 721 and the second helical conical surface of the truncated conical body 722, that is, the small diameter of the external thread 9, is connected by an inner sharp corner structure and forms a outer helical line 8 distributed spirally. For the same helical of the bidirectional truncated conical body 71, the joint between the first helical conical surface of the truncated conical body 721 and the neighbouring second helical conical surface of the truncated conical body 722, and/or the joint between the second helical conical surface of the truncated conical body 722 and the neighbouring first helical conical surface of the truncated conical body 721, that is, the major diameter of the external thread 9, is connected by an outer sharp corner structure and forms a outer helical line 8 distributed spirally. For the same helical of the bidirectional tapered hole 41, the joint between the first helical conical surface of the tapered hole 421 and the second helical conical surface of the tapered hole 422, that is, the small diameter of the internal thread 6, is connected by an outer sharp corner structure and forms a inner helical line 5 distributed spirally. For the same helical of the bidirectional tapered hole 41, the joint between the first helical conical surface of the tapered hole 421 and the neighbouring second helical conical surface of the tapered hole 422, and/or the joint between the second helical conical surface of the tapered hole 422 and the neighbouring first helical conical surface of the tapered hole 421, that is, the major diameter of the internal thread 6, is connected by an inner sharp corner structure and forms a inner helical line 5 distributed spirally. The thread structure is more compact, the strength is higher, the bearing value is large. It has good mechanical connection, locking and sealing performance, and the physical space for taper thread processing is more spacious.

The connection pair of dumbbell-like shape asymmetric bidirectional tapered threads is connected in transmission through the screw connection of the bidirectional tapered hole 41 and the bidirectional truncated cone body 71, and the load is bidirectional. When the external thread 9 and the internal thread 6 form a thread pair 10, there must be a clearance 101 between the bidirectional truncated cone body 71 and the bidirectional tapered hole 41. If oil and other media are lubricated between the internal thread 6 and the external thread 9, it will easily form a bearing oil film. The clearance is conducive to the formation of the bearing oil film. The tapered thread connection pair, are equivalent to a group of sliding bearing pairs composed of one pair and/or several pairs of sliding bearings. In other words, each section of bidirectional conical internal thread 6 bidirectionally contains a corresponding section of bidirectional conical external thread 9 to form a pair of sliding bearing, and the number of sliding bearings composed is adjusted according to the application conditions. In other words, thread pitches of the effective bidirectional joint of the bidirectional conical internal thread 6 and the bidirectional conical external thread 9, that is, the effective contact envelopment of the containment and contained, should be designed according to the application conditions. By the bidirectional tapered hole 4 containing the bidirectional truncated cone body 7, radial, axial, angular, circumferential and so on, the multi-directional positioning is achieved. This produces a special composite technology of the cone pair and the thread pair to ensure the tapered thread technology, especially transmission connection accuracy, efficiency and reliability of the connection structure of bolt and nut with bidirectional tapered thread.

For connection pair of dumbbell-like shape asymmetric bidirectional tapered threads, the fastened and sealed technical performance is realized by the screw connection of the bidirectional tapered hole 41 and the bidirectional truncated cone body 71, that is, by the first helical conical surface of the tapered hole 721 and the first helical conical surface of the truncated cone body 421 sizing interference and/or the second helical conical surface of the tapered hole 722 and the second helical conical surface of the truncated cone body 422 sizing interference. According to the application conditions, loading in one direction and/or loading in two directions simultaneously is achieved. That is, with the bidirectional truncated cone body 71 and the bidirectional tapered hole 41 guided by the helical line, the inner and outer diameters of inner and outer cone are centered until the first helical conical surface of the tapered hole 421 encloses the first helical conical surface of the truncated cone body 721 to achieve loading in one direction or in two directions at the same time sizing cooperation or until sizing interference contact. Thereby, to the technical performance of mechanical mechanism connection, locking, anti-loosening, bearing, fatigue and sealing is achieved.

Therefore, for the connection pair of dumbbell-like shape asymmetric bidirectional tapered threads in this embodiment, the technical performance of transmission accuracy and efficiency, bearing capacity, self-locking locking force, anti-loosening capacity, and sealing is related to the first helical conical surface of the truncated cone body 721 and its left taper 95, that is, the first taper angle α1, the second helical conical surface of the truncated cone body 722 and its right taper 96, that is, the second taper angle α2, the first helical conical surface of the tapered hole 421 and its left taper 95, that is, the first taper angle α1, and the second helical conical surface of the tapered hole 422 and its right taper 96, that is, the second taper angle α2. The material friction coefficient, processing quality and application conditions of the columnar body 3 and the cylindrical body 2 also have a certain influence on the cone fit.

For the above-mentioned connection pair of dumbbell-like shape asymmetric bidirectional tapered threads, when the right-angled trapezoidal combined body makes one revolution at a constant speed, the axially moving distance of the right-angled trapezoidal combined body is at least twice the length of the sum of the right-angled sides of two right-angled trapezoids of which lower sides are the same, the upper sides are the same but the right-angled sides are different. This structure ensures that the first helical conical surface of the truncated cone body 721, the second helical conical surface of the truncated cone body 722, the first helical conical surface of the tapered hole 421 and the second helical conical surface of the tapered hole 422 have sufficient length. Thereby, when the conical surface of the bidirectional truncated cone body 72 is matched with the conical surface of the bidirectional tapered hole 42, it ensures sufficient effective contact area and strength as well as the efficiency required for helical movement.

For the connection pair of dumbbell-like shape asymmetric bidirectional tapered threads, when the right-angled trapezoidal combined body makes one revolution at a constant speed, the axially moving distance of the right-angled trapezoidal combined body is equal to the length of the sum of the right-angled sides of two right-angled trapezoids of which lower sides are the same, the upper sides are the same but the right-angled sides are different. This structure ensures that the first helical conical surface of the truncated cone body 721, the second helical conical surface of the truncated cone body 722, the first helical conical surface of the tapered hole 421 and the second helical conical surface of the tapered hole 422 have sufficient length. Thereby, when the conical surface of the bidirectional truncated cone body 72 is matched with the conical surface of the bidirectional tapered hole 42, it ensures sufficient effective contact area and strength as well as the efficiency required for helical movement.

For the above-mentioned bolt and nut with bidirectional tapered thread, the first helical conical surface of the truncated cone body 721 and the second helical conical surface of the truncated cone body 722 are both continuous helical surfaces or discontinuous helical surfaces; The first helical conical surface of the tapered hole 421 and the second helical conical surface of the tapered hole 422 are both continuous helical surfaces or discontinuous helical surfaces. Preferably, the first helical conical surface of the truncated cone body 721, the second helical conical surface of the truncated cone body 722, the first helical conical surface of the tapered hole 421, and the second helical conical surface of the tapered hole 422 are continuous helical surfaces.

For the above-mentioned bolt and nut with bidirectional tapered thread, when the cylindrical body 2 connecting hole is screwed into the screw-in end of the columnar body 3, there is a screw-in direction requirement, that is, the cylindrical body 2 connecting hole cannot be rotated in the opposite direction into the screw-in end of the cylindrical body 2.

For the above-mentioned connection pair of dumbbell-like shape asymmetric bidirectional tapered threads, one end of the columnar body 3 is provided with a head having a size larger than the outer diameter of the columnar body 3, and/or one and/or both ends of the columnar body 3 are provided with a head having a size smaller than the small diameter of the external tapered thread 9 of the columnar body 3 screw body 31. The connecting hole is a threaded hole provided in the nut body 21. That is to say, the columnar body 3 and the head are connected as bolt. The columnar body without the head, and/or the columnar body with the heads at both ends which are smaller than the small diameter of the bidirectional external tapered thread, and/or the columnar body with no-thread in the middle and bidirectional external tapered threads at both ends are the studs. The connecting hole is arranged in the nut body 21.

Compared with the existing technology, the advantages of the conical connection pair 10 with the connection structure of bolt and nut with bidirectional tapered thread are: reasonable design, simple structure, the function of fastening and connection realized by the bidirectional load-bearing of cone pair which is formed by the inner and outer coaxial diameters positioning of the inner and outer cone or sizing interference cooperation, convenient operation, large locking force, large bearing value, good anti-loosening performance, high transmission efficiency and precision, good mechanical sealing effect, good stability, prevention of loose phenomenon of connection, and self-locking and self-positioning functions.

### Embodiment 2

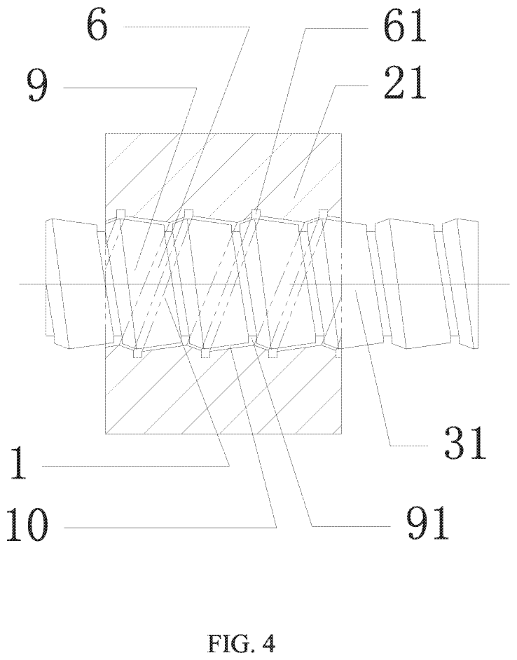

As shown in FIG. 4, the structure, principle, and implementation steps of this embodiment are similar to those of Embodiment 1. The difference is that the small diameter of the external thread 9 is processed by an external helical structure connected with a groove 91. The external helical structure is a special outer helical line 8. The major diameter of the internal thread 6, that is, the junction of adjacent helical conical surfaces, is processed by an internal helical structure connected with a groove 61. The internal helical structure is a special inner helical line 5, which can avoid interference when the internal thread 6 and the external thread 9 are screwed together, and can also store oil and dirt.

### Embodiment 3

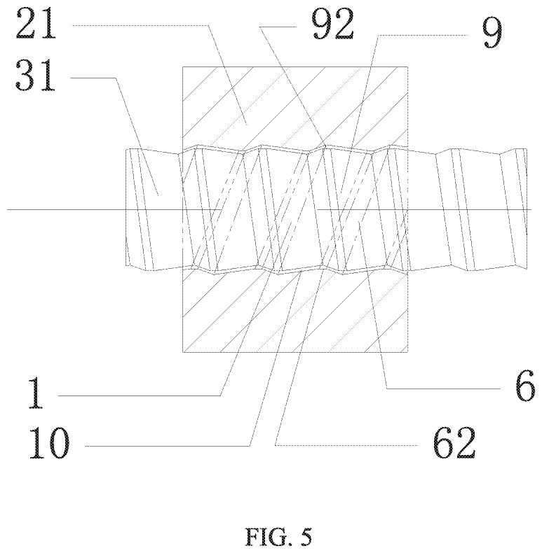

As shown in FIG. 5, the structure, principle, and implementation steps of this embodiment are similar to those of Embodiment 1. The difference is that the major diameter of the external thread 9, that is, the junction of adjacent helical conical surfaces, is processed by an external helical structure connected with a flat top or arc 92. The external helical structure is a special outer helical line 8. The small diameter of the internal thread 6 is processed by an internal helical structure connected with a flat top or arc 62. The internal helical structure is a special inner helical line 5, which can avoid interference when the internal thread 6 and the external thread 9 are screwed together, and can also store oil and dirt.

### Embodiment 4

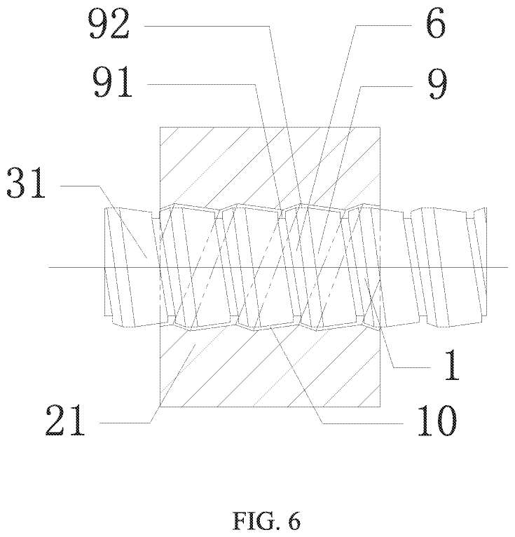

As shown in FIG. 6, the structure, principle, and implementation steps of this embodiment are similar to those of embodiment 1. The differences are as follows. The small diameter of the external thread 9 is processed by an external helical structure connected with a groove 91. The major diameter of the external thread 9, that is, the junction of adjacent helical conical surfaces, is processed by an external helical structure connected with a flat top or arc 92. The external helical structure is a special outer helical line 8. The major and small diameters of the internal thread 6 forming the thread pair 10 are connected by sharp corner, which can avoid the possible R angle that make up the thread pair 10. It can also avoid interference when the internal thread 6 and the external thread 9 are screwed together, and can also store oil and dirt.

### Embodiment 5

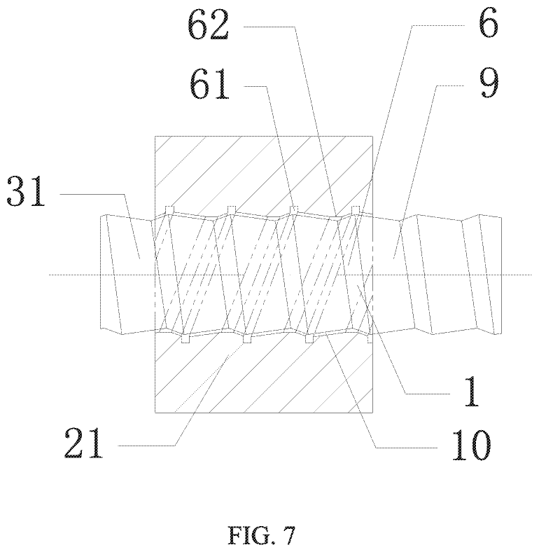

As shown in FIG. 7, the structure, principle, and implementation steps of this embodiment are similar to those of embodiment 1. The differences are as follows. The major diameter of the internal thread 6, that is, the junction of adjacent helical conical surfaces, is processed by an internal helical structure connected with a groove 61. The small diameter of the internal thread 6, that is, the junction of adjacent helical conical surfaces, is processed by an internal helical structure connected with a flat top or arc 62. The internal helical structure is a special inner helical line 5. The major and small diameters of the external thread 9 forming the thread pair 10 are connected by sharp corner, which can avoid the possible R angle that make up the thread pair 10. It can also avoid interference when the internal thread 6 and the external thread 9 are screwed together, and can also store oil and dirt.

The specific embodiments described herein are merely examples to illustrate the spirit of the present disclosure. Those skilled in the technical field to which the present disclosure pertains can make various modifications, additions or similar alternatives to the specific embodiments described, but they will not deviate from the spirit of the present disclosure or exceed the definition range of the appended claims.

Although the terms are used in this article, such as tapered thread 1, cylindrical body 2, nut body 21, nut body 22, columnar body 3, screw body 31, tapered hole 4, bidirectional tapered hole 41, conical surface 42 of the tapered hole, first helical cone surface of the tapered hole 421, first taper angle α1, second helical cone surface of the tapered hole 422, second taper angle α2, internal helical line 5, internal thread 6, bidirectional conical internal thread groove 61, bidirectional conical internal thread flat top or arc 62, truncated cone body 7, bidirectional truncated cone body 71, cone surface of bidirectional truncated cone body 72, first helical conical surface 721 of the truncated cone body, first taper angle α1, second helical cone surface of the truncated cone body 722, second taper angle α2, external helical line 8, external thread 9, bidirectional conical external thread groove 91, bidirectional conical external thread flat top or arc 92, dumbbell-like shape 94, left taper 95, right taper 96, left-direction distribution 97, right-direction distribution 98, thread connection pair and/or thread pair 10, clearance 101, self-locking force, self-locking, self-positioning, pressure, cone axis 01, thread axis 02, mirrored, axis sleeve, axis, single cone body, double cones body, cone, internal cone, tapered hole, external cone, cone pair, helical structure, helical motion, threaded body, complete unit body thread, axial force, axial force angle, anti-axial force, anti-axial force angle, centripetal force, reverse central force, reverse collinearity, internal stress, bidirectional force, unidirectional force, sliding bearing, and sliding bearing pair, they do not exclude the possibility of using other terms. These terms are used only to describe and explain the essence of the present disclosure more conveniently. To interpret them as any additional limitation is against the spirit of the present disclosure.

What is claimed is:

1. A connection pair of threads outlining asymmetrically and bidirectional tapered dumbbell-like shape having smaller-end conical degree, that is, a connection pair of dumbbell-like shape (a left taper is smaller than a right taper) asymmetric bidirectional tapered threads, comprising an external thread (9) and an internal thread (6) threaded with each other; wherein a complete unit thread of the dumbbell-like shape (the left taper is smaller than the right taper) asymmetric bidirectional tapered thread is a helical dumbbell-like shape (94) bidirectional cone with small middle and big ends, and the left taper (95) the is smaller than the right taper (96); the above-mentioned complete unit thread comprises a bidirectional tapered hole (41) and a bidirectional truncated cone body (71);
a threaded body of the internal thread (6) is an inner surface of a cylindrical body (2) presenting as a helical bidirectional tapered hole (41) and exists in a form of “non-solid space”; a threaded body of the external thread (9) is an outer surface of a columnar body (3) presenting as the helical bidirectional truncated cone body (71) and exists in a form of “material entity”;
for the above-mentioned asymmetric bidirectional cone, the left conical surface forms the left taper (95) corresponding to the first taper angle (α1), the right conical surface forms the right taper (96) corresponding to the second taper angle (α2); the left taper (95) and right taper (96) are opposite and the taper is different; the above-mentioned internal thread (6) and external thread (9) bear each other by the tapered hole enclosing the cone; the technical performance mainly depends on the matching conical surfaces of threaded body and taper; preferably, 0°<the first taper angle (^{α}1)<53°, 0°<the second taper angle (^{α}2)<530, for individual special fields, preferably, 53°≤the second taper angle (^{α}2)<180.

2. The connection pair of threads according to claim 1, wherein the dumbbell-like shape (94) bidirectional internal thread (6) comprises a first helical conical surface (421) of the tapered hole, a second helical conical surface (422) of the tapered hole, and an internal helical line (5);
a third shape formed by the first helical conical surface (421) of the tapered hole and the second helical conical surface (422) of the tapered hole is the same as a shape of a helical outer flank of a second rotating body; wherein the second rotating body is formed by a second right-angled trapezoid union being rotated around a right-angled side of the second right-angled trapezoid union, and, at the same time, the second right-angled trapezoid union axially moves at a constant speed along the central axis of the cylindrical nut (2); wherein the second right-angled trapezoid union is formed by oppositely jointing two symmetrical upper sides of two right-angled trapezoids; wherein the two right-trapezoids have identical lower sides and upper sides, and same and/or different right-angled sides; wherein the two right-trapezoids are coincident with the central axis of the cylindrical nut (2);
the external thread (9) comprises a first helical conical surface (721) of the truncated cone body, a second helical conical surface (722) of the truncated cone body, and an external helical line (8);
a fourth shape formed by the first helical conical surface (721) of the truncated cone body and the second helical conical surface (722) of the truncated cone body, is the same as the shape of a helical outer flank of the second rotating body, wherein the second rotating body is formed by the second right-angled trapezoid union being rotated around the right-angled side of the second right-angled trapezoid union, and, at the same time, the second right-angled trapezoid union axially moves at constant speed along the central axis of the columnar body (3); wherein the second right-angled trapezoid union is formed by oppositely jointing two symmetrical upper sides of the two right-angled trapezoids; wherein the two right-trapezoids have identical lower sides and upper sides, and same and/or different right-angled sides; wherein the two right-trapezoids are coincident with the central axis of the columnar body (3).

3. The bidirectional tapered thread according to claim 2, wherein when the right-angled trapezoid union rotates a circle at a constant speed, an axial movement distance of the right-angled trapezoid union is at least double a length of the sum of the right-angled sides of the two right-angled trapezoids of the right-angled trapezoid union.

4. The bidirectional tapered thread according to claim 2, wherein when the right-angled trapezoid union rotates a circle at a constant speed, an axial movement distance of the right-angled trapezoid union is equal to a length of the sum of the right-angled sides of the two right-angled trapezoids of the right-angled trapezoid union.

5. The connection pair of threads according to claim 1, wherein the first helical conical surface (421) of the tapered hole and the second helical conical surface (422) of the tapered hole, and the internal helical line (5) are continuous helical surfaces or discontinuous helical surfaces; and/or
the first helical conical surface (721) of the truncated cone body and the second helical conical surface (722) of the truncated cone body, and the external helical line (8) are continuous helical surfaces or discontinuous helical surfaces.

6. The connection pair of threads according to claim 1, wherein the internal thread (6) is formed by oppositely jointing two symmetrical upper sides of two tapered holes (3), wherein the two tapered holes have identical lower sides and upper sides, and same and/or different taper height; wherein the lower sides of the two tapered holes are located at two ends of the bidirectional tapered holes (41), and are respectively jointed with the lower sides of the adjacent bidirectional tapered holes;
the external thread (9) is formed by oppositely jointing two symmetrical upper bottom sides of two truncated cone bodies, wherein the two truncated cone bodies have identical lower sides and upper sides, and same and/or different taper height; wherein the lower sides of the two truncated cone bodies are located at two ends of the bidirectional truncated cone body (41), and are respectively jointed with the lower sides of the adjacent bidirectional truncated cone bodies.

7. The connection pair of threads according to claim 1, wherein a major diameter of the external thread (9) adopts an external shape corner structure, a small diameter of the external thread (9) adopts an internal shape corner structure, a major diameter of the internal thread (6) adopts an internal shape corner structure, and a small diameter of the internal thread (6) adopts an external sharp corner structure; and/or the small diameter of the external thread (9) adopts the groove (91) structure treatment, the major diameter of the internal thread (6) adopts the groove (61) structure treatment while the major diameter of the external thread (9) and the small diameter of the internal thread (6) stay sharp corner structure; and/or the major diameter of the external thread (9) adopts the flat top or arc (92) structure treatment, the small diameter of the internal thread (6) adopts the flat top or arc (62) structure treatment while the small diameter of the external thread (9) and the major diameter of the internal thread (6) stay sharp corner structure; and/or the small diameter of the external thread (9) adopts the groove (91) structure treatment, the major diameter of the internal thread (6) adopts the groove (61) structure treatment while the major diameter of the external thread (9) adopts the flat top or arc (92) structure treatment, the small diameter of the internal thread (6) adopts the flat top or are (62) structure treatment.

8. The connection pair of threads according to claim 1, wherein the internal thread (6) and the external thread (9) form the thread pair (10); in other words, the helical bidirectional tapered hole (41) and the helical bidirectional truncated cone body (71) under the guidance of the helical line are sizing cooperation to form sections of the cone pairs which form a thread pair (10); there is a clearance (101) between the bidirectional truncated cone body (71) and the bidirectional tapered hole (41); each section of bidirectional conical internal thread (6) contains a corresponding section of bidirectional conical external thread (9) coaxially centering and sizing to form a pair of sliding bearing; the entire threaded connection pair (10) comprises one or several pairs of sliding bearings; the number of containing and contained sections effectively bidirectionally jointed or contacting is designed according to the application conditions; the internal thread (6) tapered hole (4) bidirectionally contain the external thread (9) the truncated cone body (7); it is positioned in multiple directions such as the radial, circumferential, angular and axial directions; each section of internal thread (6) and external thread (9) includes one side bidirectional load bearing and/or two sides of the left and right bidirectional load bearing.

9. The connection pair of threads according to claim 1, wherein the internal thread (6) and the external thread (9) form the thread pair (10); in other words, the first helical cone surface of tapered hole (421), the second helical cone surface of tapered hole (422), the matching first helical cone surface of the truncated cone body (721) and the matching second helical cone surface of the truncated cone body (722) take the contacting surface as the supporting surface; under the guidance of the helical line, the inner and outer diameters of the inner cone and the outer cone are centred until the cone surface of bidirectional tapered hole (42) and the cone surface of bidirectional truncated cone body (72) are entangled so that the helical cone surface is loaded in one direction and/or two directions at the same time, and/or until the sizing self-positioning contact and/or until the sizing interference producing self-locking.

10. The connection pair of threads according to claim 1, wherein the columnar body (3) can be solid or hollow, comprising workpieces and objects such as columnar and/or non-columnar bodies that need to be processed with a bidirectional conical external thread (9) on the outer surface;
the cylindrical body (2) comprises workpieces and objects such as cylindrical and/or non-cylindrical bodies that need to be processed with a bidirectional conical internal thread (6) on the inner surface;
the above-mentioned outer and/or inner surfaces include surface geometry such as cylindrical and/or conical surfaces and other non-cylindrical surfaces.

11. The connection structure according to claim 1, wherein the above-mentioned internal thread (6) and/or external thread (9) comprises a single thread body which is an incomplete conical geometry body, that is, a single thread body is an incomplete unit body thread.
